(19) United States
(12) Patent Application Publication
(10) Pub. No.: US 2010/0009553 A1
(43) Pub. Date: Jan. 14, 2010

(54) CONNECTOR ASSEMBLY

(75) Inventors: XIONG LI, Shenzhen City (CN); KIM-YEUNG SIP, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen)CO., LTD., Shenzhen City (CN); HON HAI PRECISION INDUSTRY CO., LTD., Tu-Cheng (TW)

(21) Appl. No.: 12/233,546

(22) Filed: Sep. 18, 2008

(30) Foreign Application Priority Data
Jul. 8, 2008 (CN) 200810302654.4

(51) Int. Cl. H01R 12/00

(52) U.S. Cl. 439/62

(57) ABSTRACT

A connector assembly includes a substrate and a connector mounted thereon. The substrate defines a cutout. The connector includes a housing and an array of terminals. The housing has a pair of guiding arms and a cross bar bridged between the guiding arms to collectively define a receiving space therebetween corresponding to the cutout. The array of terminals is assembled on the cross bar and electrically connected to the substrate.

### TECHNICAL FIELD

The present invention relates to a connector assembly and, particularly, to a connector assembly of compact flash cards.

### DESCRIPTION OF THE RELATED ART

Conventionally, there are two types of compact flash card connectors. The first type is relatively shorter in height, while the second type is relatively taller in height. Typically, the compact flash card connectors can only connect with the compact flash cards whose height is smaller than that of the compact flash card connectors when the first type of connector is assembled on a printed circuit board of an electronic device, thus, the types of compact flash cards capable of connecting with the circuit board is limited. In addition, when the second type of connector is assembled on the printed circuit board of an electronic device, the second type of connector cause the electronic device to be bulky and limit the miniaturization of possible designs.

What is needed, therefore, is a connector to allow for greater connectivity.

### BRIEF DESCRIPTION OF THE DRAWINGS

Many aspects of the present connector assembly can be better understood with references to the accompanying drawings. The components in the drawing are not necessarily drawn to scale, the emphasis instead being placed upon clearly illustrating the principles of the present connector assembly.

FIG. 1 is a schematic view of a connector assembly according to an exemplary embodiment.

FIG. 2 is a schematic view of the connector assembly of FIG. 1 after being inserted with a compact flash card according to the exemplary embodiment.

### DETAILED DESCRIPTION OF THE EMBODIMENTS

Embodiments of the present invention will now be described in detail below, with references to the accompanying drawings.

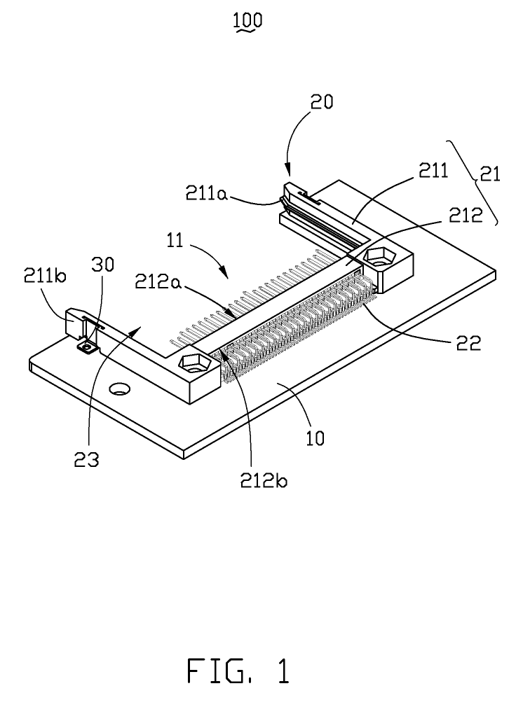

Referring to FIG. 1, a connector assembly 100 of an electronic device according to a first exemplary embodiment is shown. In the present embodiment, the connector assembly 100 is configured for connecting with a compact flash card. The connector assembly 100 includes a substrate 10 and a connector 20 mounted on the substrate 10.

The connector 20 includes a housing 21 and an array of terminals 22. The housing 21 includes a pair of guiding arms 211 and a cross bar 212 bridged between the pair of guiding arms 211 to collectively define a receiving space 23 therebetween. The cross bar 212 has a mating face 212a and a rear face 212b opposite to the mating face 212a, along with an array of passageways (not labeled) defined between the mating face 212a and the rear face 212b. The array of terminals 22 is assembled in the array of passageways. A pair of guiding ribs 211a is formed on inner walls of the guiding arms 211 for guiding a card to be inserted. The guiding ribs 211a may be replaced with guiding grooves if needed.

In the present embodiment, the substrate 10 is a printed circuit board and is electrically connected with the array of terminals 22. The substrate 10 defines a cutout 11 corresponding to the receiving space 23 defined by the pair of guiding arms 211 and the cross bar 212. The size of the cutout 11 is substantially greater than or equal to the size of the receiving space 23. The connector 20 is mounted on the substrate 10, with the pair of guiding arms 211 and the cross bar 212 thereof surrounding three sides of the cutout 11.

The connector 20 can be secured on the substrate 10 by soldering and screws, among other methods. In the present embodiment, the connector assembly 100 also has two L-shaped connecting devices 30 for securing the connector 20 on the substrate 10. The connecting devices 30 are located at the front end 211b of the guiding arms 211, respectively. The front end 211b of the guiding arm 211 is away from the cross bar 212.

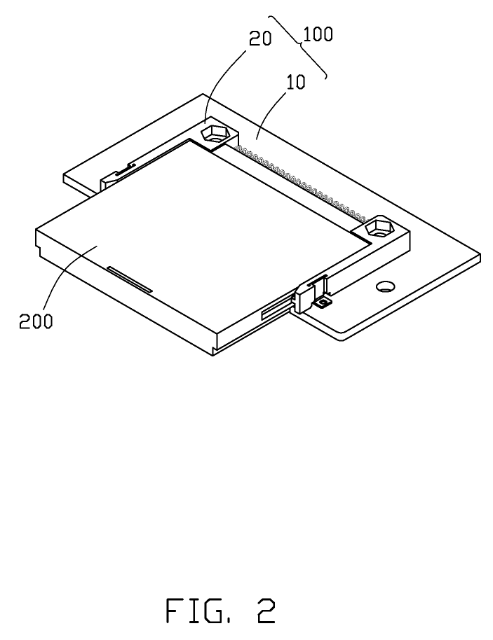

Referring to FIG. 2, a compact flash card 200 is inserted into the connector 20 of the connector assembly 100. As a result of the cutout 11 of the substrate 10, the connector 20 is able to accept both compact flash card that is thinner than that of the connector 20 and a compact flash card 200 that is thicker than that of the connector 20. The cutout enables compact flash cards of all thickness to be connected.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

What is claimed is:

1. A connector assembly comprising:
a substrate defining a cutout; and
a connector mounted on the substrate, the connector comprising:
a housing comprising a pair of guiding arms and a cross bar bridged between the guiding arms to collectively define a receiving space therebetween corresponding to the cutout; and
an array of terminals assembled on the cross bar and electrically connected to the substrate.

2. The connector assembly as claimed in claim 1, wherein the inner surface of the pair of guiding arms has guiding means formed thereon.

3. The connector assembly as claimed in claim 2, wherein the guiding means are guiding grooves.

4. The connector assembly as claimed in claim 2, wherein the guiding means are guiding ribs.

5. The connector assembly as claimed in claim 1, wherein the cross bar comprises a mating face and a rear face opposite to the mating face, along with an array of passageways defined between the mating face and the rear face, the array of the terminals is assembled in the array of passageways.

6. The connector assembly as claimed in claim 1, wherein the substrate is a printed circuit board.

7. The connector assembly as claimed in claim 1, further comprises two connecting devices for securing the front end of the guiding arms on the substrate.

8. The connector assembly as claimed in claim 1, wherein the size of the cutout is substantially equal to that of the receiving space.

9. The connector assembly as claimed in claim 1, wherein the size of the cutout is bigger than that of the receiving space.

10. An electronic device comprising:
a substrate defining a cutout; and
a connector mounted on the substrate, the connector comprising:
a housing comprising a pair of guiding arms and a cross bar bridged between the guiding arms to collectively define a receiving space therebetween corresponding to the cutout; and
an array of terminals assembled on the cross bar and electrically connected to the substrate, and
a card detachably connected with the connector.

11. The electronic device as claimed in claim 10, wherein the inner surface of the pair of guiding arms has guiding means formed thereon.

12. The electronic device as claimed in claim 11, wherein the guiding means are guiding grooves.

13. The electronic device as claimed in claim 11, wherein the guiding means are guiding ribs.

14. The electronic device as claimed in claim 10, wherein the cross bar comprises a mating face and a rear face opposite to the mating face, along with an array of passageways defined between the mating face and the rear face, the array of the terminals is assembled in the array of passageways.

15. The electronic device as claimed in claim 10, wherein the substrate is a printed circuit board.

16. The electronic device as claimed in claim 10, further comprises two connecting devices for securing the front end of the guiding arms on the substrate.

17. The electronic device as claimed in claim 10, wherein the size of the cutout is substantially equal to that of the receiving space.

18. The electronic device as claimed in claim 10, wherein the size of the cutout is bigger than that of the receiving space.
